(19) United States
(12) Patent Application Publication
(10) Pub. No.: US 2009/0300887 A1
(43) Pub. Date: Dec. 10, 2009

(54) One way adjustable locking device

(76) Inventor: John Robert Zambetti, Southington, CT (US)

Correspondence Address: JOHN R. ZAMBETTI, 178 COMMISSION STREET, SOUTHINGTON, CT, 06489, US

(21) Appl. No.: 12/157,983

(22) Filed: Jun. 4, 2008

(51) Int. Cl. F16G 11/12

(52) U.S. Cl. 24/115 R

(57) ABSTRACT

the present invention provides a one way adjustable locking device for tensioning and securing a flexible line. The device has a cavity in it which has a bottom and or top tapered on an angle. This creates a cavity with the height on one end smaller that the other. A pin or ball is then assembled and retained into the cavity. The pin or ball travels up and down the cavity which is on an angle. The strapping, rope, or twine is threaded into the device above or underneath the pin or ball. The interference fit between the line and the pin or ball against the top or bottom of the cavity moves the pin or ball up or down the angled cavity depending on the direction the line is pulled. The design of the device enables the line to be adjusted and tensioned when pulled in the direction of the largest opening in the cavity. When the line is pulled in the direction of the smallest opening in the cavity the pin or ball binds the line at the smallest point retaining the applied tension and preventing the line from traveling in the same direction pulled. This is what creates the unique one-way locking feature.

### BACKGROUND OF THE INVENTION

1. Field of the Invention

The present invention relates to a one way adjustable locking device for tensioning and securing a flexible line, such as rope, twine or strapping.

2. Description of Related Art

There has always been a need to secure a line or use a line to secure an object. One end of the line is usually secured first then the free end of the line needs to be pulled taut and tied off to itself or to an object to secure it. Many times to secure an object the line is wrapped around the object and the line's ends secured to each other.

Many types of tensioning and securing devices have been developed and are well suited for their intent, but are too costly, cumbersome and not user friendly.

As can be seen by reference to the following U.S. Pat. Nos. 3,222,745; 3,703,024; 4,136,422; 4,719,668; and 6,049,950 the prior art is replete with myriad and diverse tensioning and securing devices.

While all of the aforementioned prior art constructions are more than adequate for the basic purpose and function for which they have been specifically designed, they are uniformly deficient with respect to their failure to provide a cost effective, simple tensioning and securing device that would accommodate all types of lines.

As a consequence of the foregoing situation, there has existed a longstanding need for a new and improved tensioning and securing device, and the provision of such a construction is a stated objective of the present invention.

### BRIEF SUMMARY OF THE INVENTION

Briefly stated, the present invention provides a one way adjustable locking device for tensioning and securing a flexible line. The device has a cavity in it which has a bottom and or top tapered on an angle. This creates a cavity with the height on one end smaller that the other. A pin or ball is then assembled and retained into the cavity. The pin or ball travels up and down the cavity which is on an angle. The strapping, rope, or twine is threaded into the device above or underneath the pin or ball. The interference fit between the line and the pin or ball against the top or bottom of the cavity moves the pin or ball up or down the angled cavity depending on the direction the line is pulled. The design of the device enables the line to be adjusted and tensioned when pulled in the direction of the largest opening in the cavity. When the line is pulled in the direction of the smallest opening in the cavity the pin or ball binds the line at the smallest point retaining the applied tension and preventing the line from traveling in the same direction pulled. This is what creates the unique one-way locking feature.

The present invention will provide countless tensioning and securing uses but will primarily be used in the hardware industry providing a low cost, one way adjustable, locking device for tensioning and securing a flexible line.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1—is a front view of the unassembled one way adjustable locking device of the present invention;

FIG. 2—is a cross-sectioned unassembled side view of the present invention showing the bottom of the cavity angled front to back;

FIG. 3—is a perspective view of the pin used in the assembly of the present invention;

FIG. 4—is a perspective view of the staple used for retaining the pin into the cavity of the present invention;

FIG. 5—is a cross-sectioned side view of the complete assembly of the present invention showing the pin assembled into the cavity, the staple assembled into the housing and the line assembled into the complete assembly. This view also shows how the present invention allows the line to be adjusted when pulled in the direction of the arrows and the position of the pin while the line is being adjusted;

FIG. 6—is a cross-sectioned side view of the complete assembly of the present invention showing how the present invention creates its' unique tensioning and locking features. This view shows the line being pulled in the direction of the arrows which retains the applied tension locking the line in place and the position of the pin while in the locking position;

FIG. 7—is a perspective view of present invention being utilized on both ends of a line and connected to a cable tie used to secure each end of the line prior to adjusting and tensioning the line;

FIG. 8 is an alternative perspective view of present invention being utilized on both ends of a line and incorporated into the construction of a hook used to secure each end of the line prior to adjusting and tensioning the line;

FIG. 9—is a cross-sectioned side view of the complete assembly of the present invention showing how the present invention can be utilized to create a self contained securing device.

FIG. 10—is an alternate cross-sectioned side view of the complete assembly of the present invention showing how the present invention can be utilized to create a self contained securing device.

FIG. 11—is an alternate sectioned side view of the complete assembly of the present invention showing how the present invention can be utilized to create a self contained securing device.

### DETAILED DESCRIPTION OF THE INVENTION

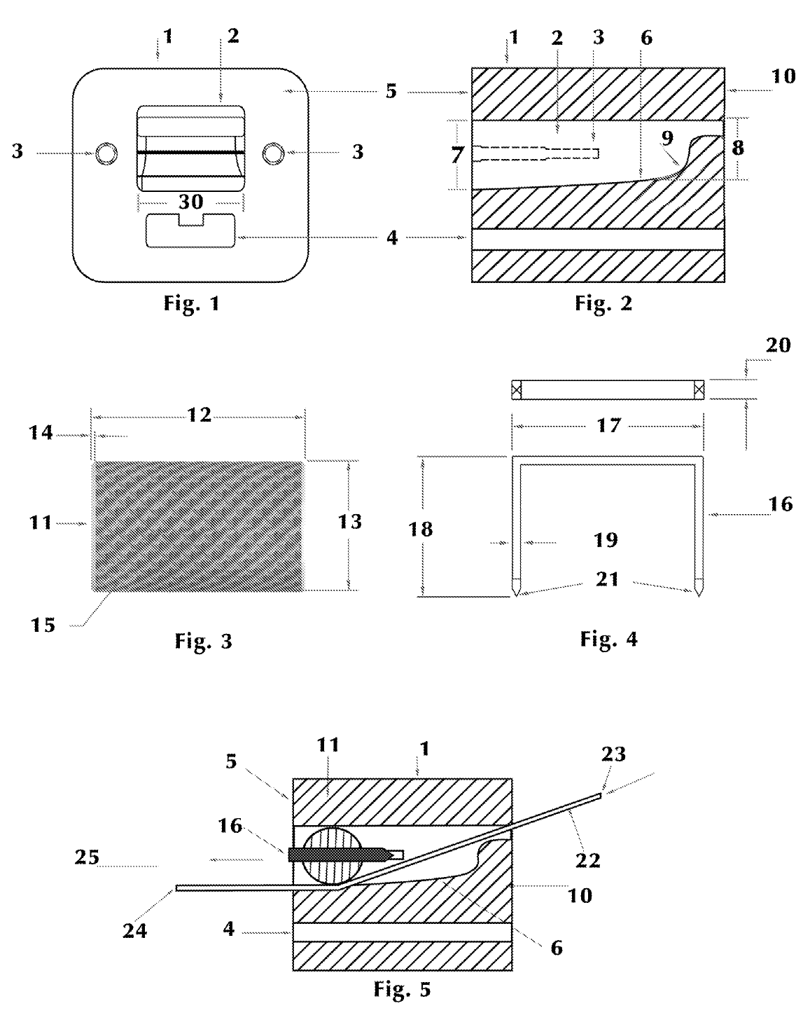

As can be seen by reference to the drawings, and in particular to FIGS. 1-6, the one way adjustable locking device for tensioning and securing a flexible line that forms the basis of the present invention is designated generally by the reference number 25.

As best shown in FIGS. 1-4, the one way adjustable locking device 25 includes a housing 1 (FIG. 1&2), a pin 11 (FIG. 3) and a staple 16 (FIG. 4).

The housing 1 contains a cavity 2. The width 30 of the cavity 2 is designed to fit the length 12 of the pin 11 with just enough clearance to allow the pin 11 to move freely along the length of the cavity 2. The bottom 6 of the cavity 2 is tapered up on an angle along the length of the cavity 2 from the front 5 to the back 10 of the housing 1. The angled bottom 6 can be seen by the height difference between the front 7 of the cavity 2 and the back 8 of the cavity 2. The back end of the angled bottom 6 has a pin 11 stop 9. This stop 9 helps increase the retention strength of the device and creates part of the locking feature of the present invention.

The pin's length 12 to diameter 13 ratio are specifically designed to prevent the pin 11 from binding in the width 30 of the cavity 2 of the housing 1. A chamfer 14 is also used on the pin 11 ends to prevent binding. The surface 15 of the pin 11 has a diamond knurl finish to help engage the line during operation.

The staple 16 is used to retain the pin 11 into the housing 1. The ends 21 of the staple 16 are assembled into the holes 3 on the housing 1. The width 17 of the staple 16 is designed to be centered in the holes 3 of the housing 1. The holes 3 in the housing 1 are smaller than the width 20 of the staple 16 to create enough interference fit to prevent the staple 16 from coming loose during the adjusting function of the present invention.

As best shown in FIGS. 5&6, the one way adjustable locking device complete assembly 25 consists of the pin 11 being assembled into the cavity 2 and the staple 16 assembled into the holes 3 in the housing 1. FIG. 5 shows the adjusting features of the present invention. A line 22 is inserted into the back 10 of the housing 1 and underneath the pin 11 as shown. This causes the pin 11 to move to the front 5 of the housing 1. When the pin 11 is at the largest opening 7 of the cavity 2 the line 22 is allowed to go under the pin 11. The largest opening 7 of the cavity 2 is specifically design to allow the line 22 enough clearance to be adjusted when pulled in the direction shown in FIG. 5, but still have a slight interference fit to engage the line 22 pulling the pin 11 back when the line 22 is pulled in the opposite direction.

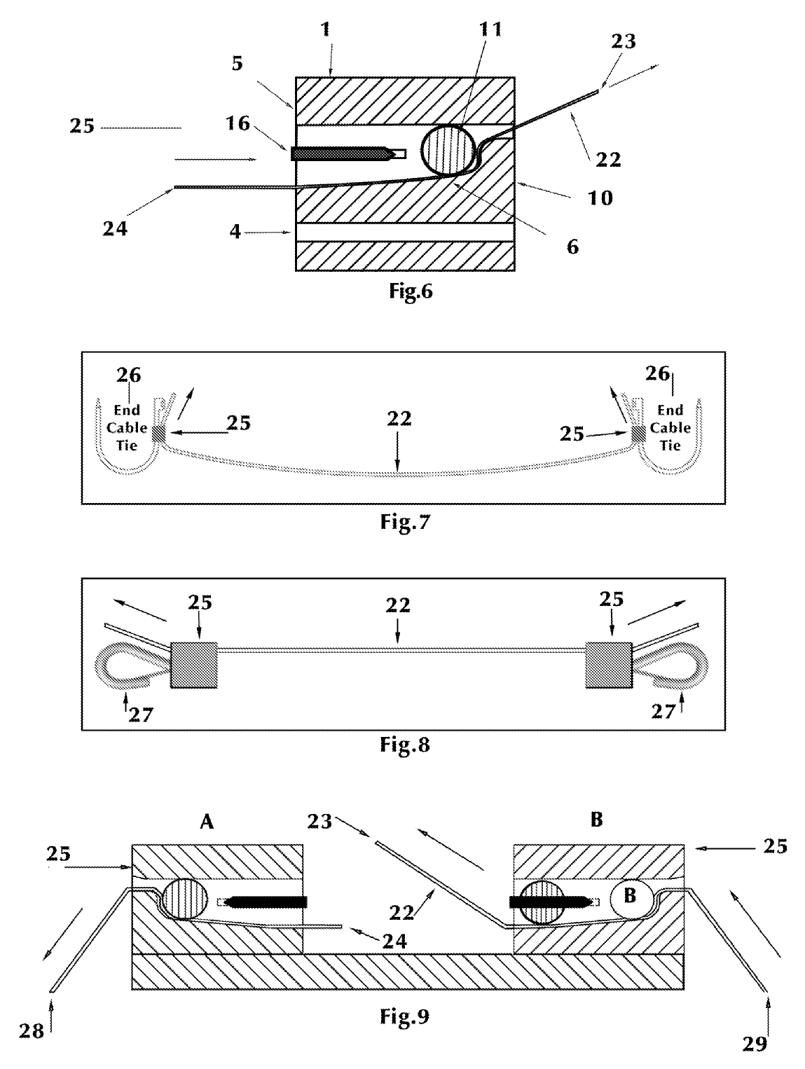

FIG. 6 shows the locking and tensioning features of the present invention. After the line 22 is adjusted and/or tension is applied as described above and seen in FIG. 5, the line 22 is released. When the line 22 is pulled in the opposite direction, manually or from the applied tension, the interference fit between the cavity 2, the pin 11 and the line 22, causes the pin 11 to be pulled up the angled bottom 6 from the front 5 to the back 10 of the cavity 2 in the housing 1. As the pin 11 travels up the angled bottom 6 the interference fit between the cavity 2, the pin 11 and the line 22 increases as the force applied to pulling the line 22 increases. As seen in FIG. 6 the pin 11 is shown at the end of the angled bottom 6 at the back 10 of the cavity 2. If the force applied to the line 22 is great enough a stop 9 exists to bind the pin 11 and the line 22. This feature dramatically increases the retention of the locking and/or tensioning feature of the design. The position in the cavity 2 on the angled bottom 6 the pin 11 will eventually stop depends on the manufacturing tolerances of the components used and more so the amount of force applied to the line when pulled in the locking or tensioning direction. This design is what creates the locking and tensioning feature of the present invention.

FIG. 7 shows the present invention 25 being utilized on both ends of a line 22 and a cable tie 26 connected into the housing 1 through 4. The cable tie 26 is used to secure each end of the line 22 prior to adjusting and tensioning the line 22.

FIG. 8 shows an alternative embodiment of present invention 25 being utilized on both ends of a line 22 and incorporated into the construction of a hook 27 used to secure each end of the line 22 prior to adjusting and tensioning the line.

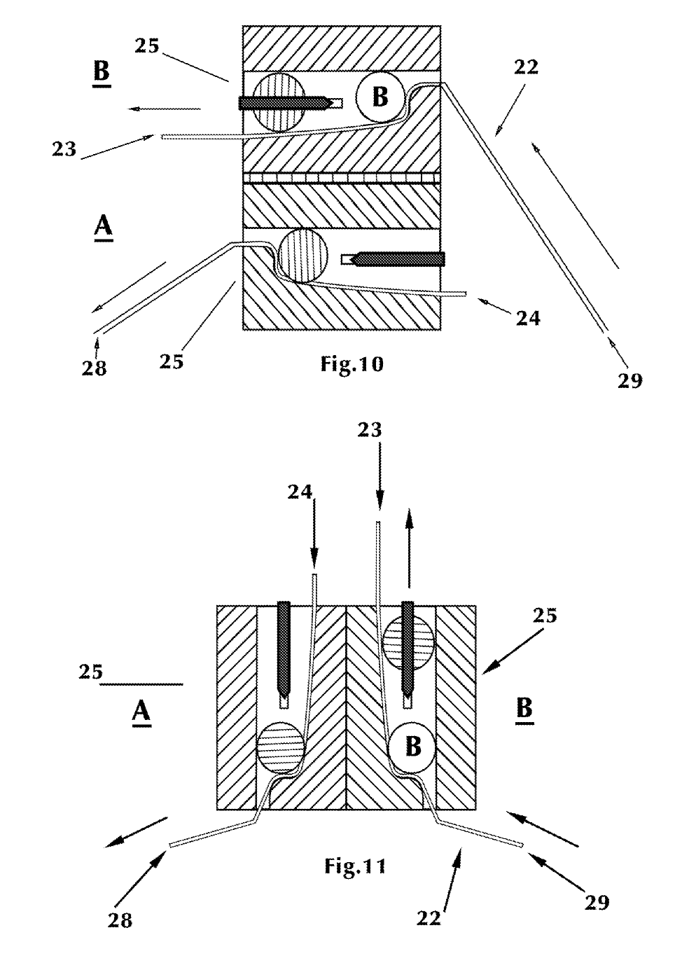

FIGS. 9-11 shows alternatives of how the present invention 25 can be utilized to create a self contained securing device. The present invention 25 is utilized twice with a side A and side B within the same construction. The first end 24 of the line 22 is inserted into side A of the present invention 25. The line 22 is then used to secure an object and the opposite end 23 is inserted into side B of the present invention 25. It is understood that the ends 28 and 29 of the line 22 shown forms a continuous loop. As the end 23 of the line 22 is pulled to secure the object and tension the line 22, side A of the present invention 25 locks the line 22 while side B is being adjusted or tensioned. When the line 22 is tensioned as desired and released the pin 11 in side B of the present invention 25 locks and secures the line 22 moving from the start position to position B as shown.

The one way adjustable locking device of the present invention 25 is useful for providing a cost effective, simple and practical device for tensioning and securing a flexible line.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. A one way adjustable locking device for tensioning and securing a flexible line comprising, a housing having a cavity with at least one wall of the cavity tapered on an angle along the length of the cavity creating a wedge shape, a pin or ball which fits into the width of the cavity rolls freely on and along the length of the angled wall(s), the length of the pin or ball, diameter of the pin or ball and width of the cavity are designed to ensure the pin or ball will not bind while moving up or down the length of the angled wall(s) of the cavity, at the largest point or end of the cavity the pin or ball is retained to prevent it from falling out, at the thinnest point or end of the cavity a back wall or stop exists as part of the housing to prevent the pin or ball from falling out and traveling any further,

2. A one way adjustable locking device for tensioning and securing a flexible line as defined in claim 1 wherein a line is inserted into the device at the thinnest point or end of the cavity and underneath the pin or ball, the device is design to allow the line to adjust when pulled in the same direction as it was inserted, when the line is pulled in the opposite direction the interference fit between the line and the pin or ball causes the pin or ball to roll up the angled wall binding the pin or ball and the line at the smallest point in the cavity retaining the applied tension and locking the line in position.
